(19) United States
(12) Patent Application Publication
(10) Pub. No.: US 2011/0120442 A1
(43) Pub. Date: May 26, 2011

(54) Barbecue Grill and Smoker

(76) Inventor: Darin Jason Duncan, Houston, TX (US)

(21) Appl. No.: 12/620,048

(22) Filed: Nov. 17, 2009

(51) Int. Cl. A47J 37/00

(52) U.S. Cl. 126/25 R

(57) ABSTRACT

A barbecue grill, have an enclosed cooking container resting upon a support structure, the cooking enclosure having walls that enclose the cooking area and a clamshell lid for access, heating elements in the lower portion of the enclosure, connected to a fuel source, and containing within the cooking enclosure heating elements in the lower portion, grills for holding food and exposing it to the circulating air in the superior portion, and a drawer or drawers for wood, water, or other substances, which can be exposed to heat for the creation of smoke, steam or other result, consequently enabling the standard grilling process, but also providing a low skill, low effort means of enabling the slow smoking process as well as the simulated cooking of food over a wood fire.

### BACKGROUND OF THE INVENTION

It is generally known that home cooks desire to produce consistently appetizing food requiring a minimum of effort and skill. A very common technique is to cook outdoors using a barbecue grill, fueled by propane, charcoal, natural gas, or wood in some combination. These devices, which include a wide variety of cooking structures and cooking methods, use different combinations of heat, smoke, humidity, and food placement in order to transform raw food into a superior finished product. These devices include have names such as gas grills, charcoal grills, electric smokers, gas smokers, water smokers, and slow smokers, among others. The most common and easiest to use of these is the simple propane grill. The present invention represents a modification of the standard propane grill that allows it to serve as both a slow smoker and to simulate cooking over a wood fire.

When making any decision on cooking technique, a variety of factors are weighed. Time and effort required to do the cooking matters, as does the quality of product, how consistently good food can be produced, the skill level required, even the cost of obtaining and operating a cooking device. It is the goal of all barbecue cooking devices to create excellent food product, with great consistency, requiring the least skill and effort, and having a low cost to own and operate. The present invention aims to provide a device that is uniquely able to achieve these objectives.

The present invention involves the combination of propane grilling and smoking, in a manner that allows for greater control of the cooking environment than existing devices. It provides for grilling in the traditional sense using only propane, which is the most common and convenient method for outdoor cooking today. In addition, the invention offers flexibility in cooking technique, allowing for both fast and slow smoking, through the addition of wood chips and water to the cooking enclosure. By adding just wood chips, users can also simulate cooking over a wood fire, which is an ancient and well known process that generates outstanding flavor elements. So unlike a simple gas grill, several cooking techniques are unified in one device.

Since propane grills are the most common outdoor cooking device, but cooking over a wood fire is often thought of as the best method for delivering flavor, various existing devices allow for the addition of wood to propane fires. Smoker boxes are available today, such as the patent D534,034, fitting inside the grill just above the burners, and generate good amounts of smoke but offer no humidity improvements to an otherwise dry atmosphere, and cannot be refilled when the wood is used up. Smoker boxes cannot therefore be used for slow smoking, and they would produce dried out food since there is no water pan. Many other methods of introducing wood flavors into food are shown in the prior art, all with similar limitations.

One device that employs the slow smoking technique is traditional slow smoker. While they are very effective in producing outstanding product, there is limited use by home cooks, due to the high cost of purchasing and operating them, the skill required in using them, and the time and effort involved in starting a wood fire and maintaining it within the desired temperature levels for the extended time required to slow smoke. The cumbersome nature of these devices, and the difficulty in controlling the internal environment, especially the temperature, has resulted in limited use of this otherwise superior cooking technique.

The use of propane has become so widespread as to be the most popular of all grilling methods. This is due to difficulties associated with charcoal fires, versus the ease of use of propane grills. Charcoal fires require increased time and effort to light, are difficult to control, and leave an ash residue. There are many cooks, however, who believe that charcoal imparts superior flavor elements to food. Propane, on the other hand, is easy to light and put out, burns clean and hot, and produces instantly controllable temperatures. As such, it has become the dominant fuel. Propane, however, imparts little to no unique flavor to food other than that imparted by high heat, i.e. caramelization, which is not unique to propane.

An ancient but uncommonly used technique is cooking over a wood fire. People are generally unfamiliar with the technique, although it is commonly recognized that wood, such as hickory or mesquite, can impart superior flavor to food. There are many restaurants that are able to charge a premium for food, such as pizza, hamburgers, steaks, and other meats, when cooked over a wood flame. Of course, traditional barbecue restaurants, which also cook food using a wood fire, generate strongly flavored food, especially for food like brisket, pork, or poultry, and often cook meat for ten hours or more using large scale, traditional slow smokers. The use of wood fires by home cooks is limited for many reasons, including the time and effort involved, as well as the safety of open fires. For these reasons among others, few outside of restaurants cook over a wood fire anymore.

If the above understanding of cooking techniques is correct, then the best cooking device would impart the flavor of wood, would enable the slow smoking technique, would be safe, would require as little time and effort as propane, and would not require large amounts of cooking skill. The present invention does this, and does it better than prior art. The present invention involves a traditional propane grill, the same basic grill structure used by more cooks than any other grill. The difference lies in the addition of anteriorly placed refillable drawers. These drawers, which slide in or out from the front of the grill, are placed directly above the propane burners in order to expose the contents of the drawers to the heat of the propane flame. This heat can be used to roast wood chips or boil water, among other things. These drawers give cooks control of the cooking environment that does not exist in prior art, allow for the additional flavor elements such as those associated with wood fires, and enable the slow smoking process through the addition of a water tray, while preserving the “instant on” convenience of propane. A second embodiment on the invention involves the placement of fixed drawers, which are also refillable and identical in function to the sliding drawers except that the grill lid must be opened for access to them.

The present invention allows for the ease of use of cooking with propane and enables the slow smoking and fast processes. When slow smoking is performed, there is much greater control of humidity and smoke than when using a traditional wood fire, because the cook has direct control of the water and wood inputs. Also, temperature control is much improved because the propane flame is easier to control than a wood fire. Less cooking time is required when slow smoking because the flame is instantly lit or put out, where lighting a wood fire is time consuming, requires practice, and is less safe than lighting a propane grill. So the present invention allows for the proper cooking and smoking of a brisket, or other meat requiring slow cooking, while a traditional propane grill cannot do this.

The present invention simulates cooking over a wood fire when wood chips are used in the refillable drawers. This is an excellent technique for hamburgers and steaks, and whole restaurant chains have profited from this very simple idea. The heat from the propane flame is applied to the drawer, resulting in combustion of wood chips and the creation of wood smoke. The result is food with the superior flavors associated with wood fires. But where wood fires are difficult to start and to put out, the wood chips will stop smoking soon after the propane flame is removed, where wood fires can takes hours or days to cool completely. Common items such as chicken, fish or hamburgers do very well with this kind of process. The only additional requirement for the cook is to buy the wood chips, which are widely available, and put them in the drawer, which need only be filled infrequently.

The present invention requires less skill to produce food than other cooking devices such as slow smokers. Slow smoking currently requires significant experience, and involves a great deal of trial and error learning how to make wood fires, to control the temperature of an existing fire, and to control the smoke and humidity of the cooking environment. Furthermore, for the home cook, outcomes are frequently inconsistent when slow smoking, being influenced by outside temperatures, variable wood flavoring components, and variable humidity. The present invention produces a consistent smoke, stable temperatures, and reliably high humidity, resulting in consistent product. Direct control of the cooking environment makes the slow smoking process much easier and greatly more accessible to “lesser skilled” cooks.

The present invention makes creating excellent barbecue easier and more convenient than ever before. Through the innovation of refillable drawers, cooks have improved control of the internal cooking environment. The difficulties associated with wood fires and traditional slow smokers are avoided. Instead, users experience the ease of use of a propane grill. The invention puts great barbecue into reach for lesser skilled cooks and cooks who wish to spend less time on the cooking process. It does so in a safe and healthy manner, and with little additional manufacturing cost. For these reasons, owners will find the present invention a uniquely valuable tool.

### BRIEF SUMMARY OF THE INVENTION

It is the principal object of the present invention to provide for a barbecue cooking apparatus capable of producing a unique combination of flavor elements with a minimum amount of cooking effort.

It is another object of the invention to require less skill to achieve excellent cooking results by allowing for simple and continuous control of the internal environment of the cooking device.

It is another object of the invention to produce high quality food product more consistently by allowing for simple and continuous control of the internal environment of the cooking device.

It is another object of the invention to enable multiple cooking techniques in a single device, including slow smoking, cooking over a wood fire, grilling over propane, and fast smoking, enabling consumers to avoid costs associated with owning and operating multiple devices.

It is another object of the invention to make the slow smoking process easier to employ, producing more consistent results, than when using traditional slow smokers.

It is another object of the invention to allow for the simulation of cooking over a wood fire, but in a manner requiring less effort and skill than other devices.

Other objects and advantages of the present invention will be apparent by reference to the following description of the instant embodiment, drawings, and claims.

### BRIEF DESCRIPTION OF THE DRAWINGS

These and other features, aspects, and advantages of the present invention will become better understood with regard to the following description, claims, and accompanying drawings:

FIG. 1a is an anterior view of the preferred embodiment of the invention, with the clamshell cover closed.

FIG. 1b is an anterior view of a second embodiment of the invention, with the clamshell cover closed.

FIG. 2 is a top view of the grilling enclosure with the cover and grills removed.

FIG. 3a is a top view of the preferred embodiment of the cooking enclosure, with the clamshell lid not shown.

FIG. 3b is a top view of a second embodiment, with the clamshell lid not shown.

FIG. 4a is a sectional view of the interior of the cooking enclosure of the preferred embodiment.

FIG. 4b is a sectional view of the interior of the cooking enclosure in the second embodiment.

FIG. 5a is a perspective view of the refillable drawer of the preferred embodiment.

FIG. 5b is a perspective view of the refillable drawer of the second embodiment

### DETAILED DESCRIPTION OF THE INVENTION

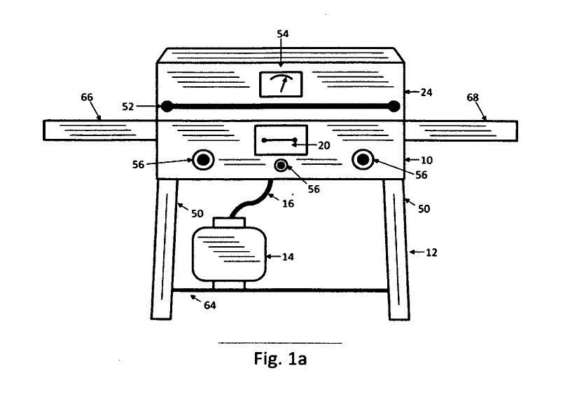

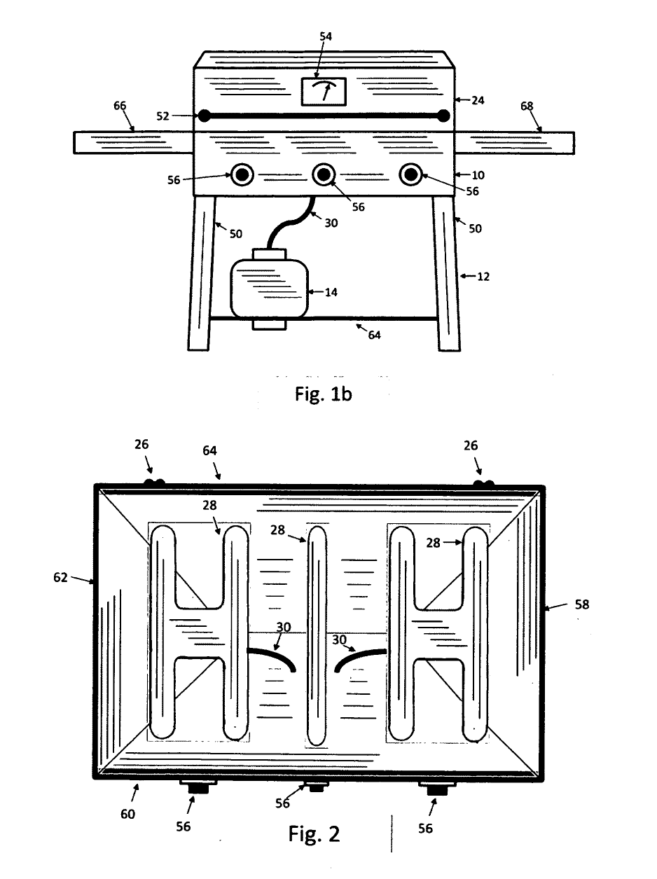

Referring to FIGS. 1, 2, 3a, 4a and 5a, in the preferred embodiment, a gas grill comprising a cooking enclosure 10, mounted upon a support structure 12, left and right sided shelves 66 and 68, a fuel source 14, a means of delivering fuel to the cooking enclosure 16, and within the cooking enclosure gas burners 28, a slideable drawer assembly 20, and grills 22 for holding food and exposing food to the cooking environment. Control of gas flow, and therefore temperatures as well as humidity and smokiness, is by gas valves, actuated by controls 56. The support structure is in this embodiment made up of four legs 50, and a lower shelf 64 for the propane tank 14.

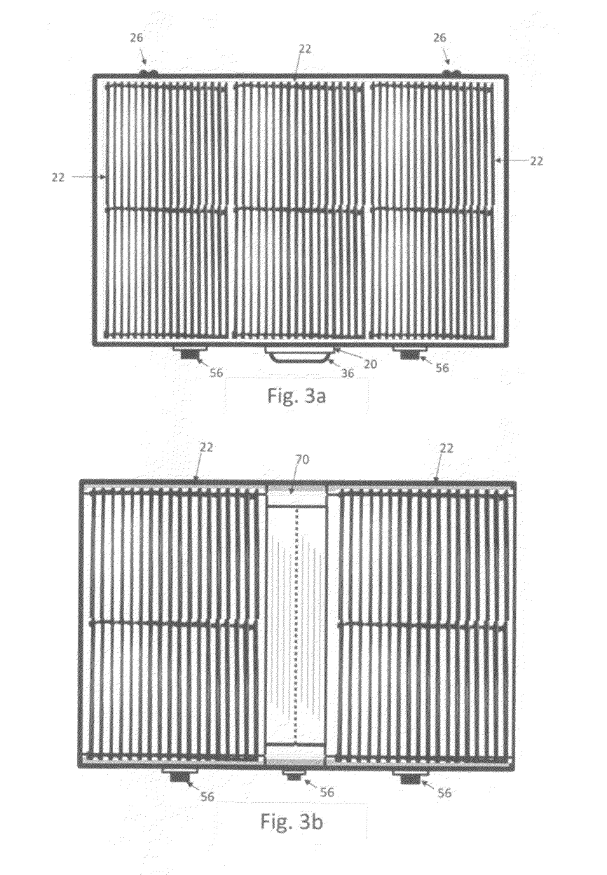

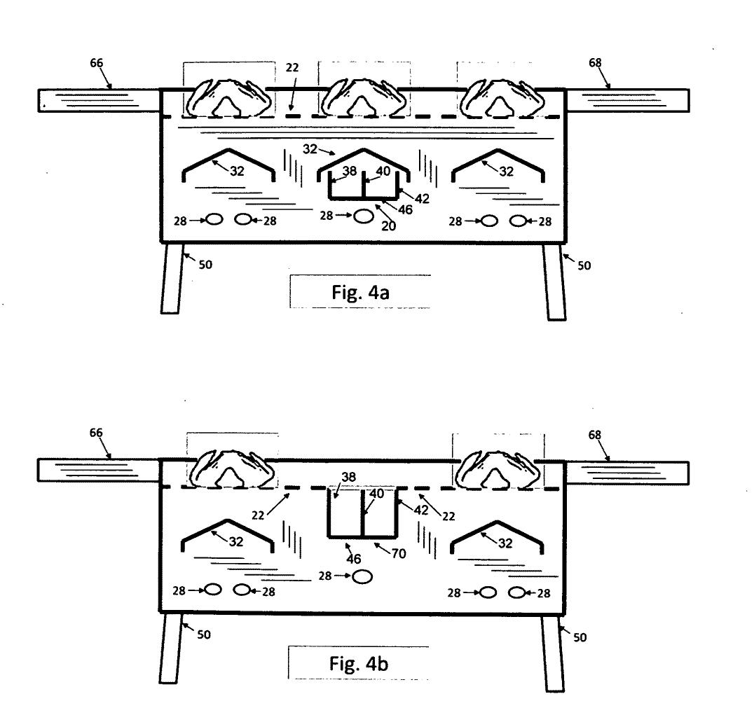

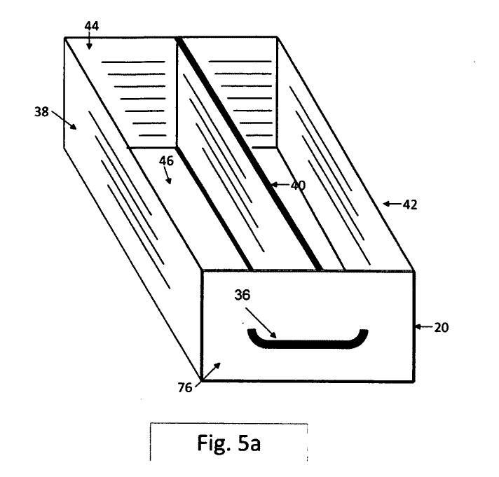

The cooking enclosure has a clamshell lid 24, holding an embedded thermometer 54, the lid opening from posteriorly placed hinges 26, by means of the handle 52. FIG. 2 shows the cooking enclosure with the lid, grills, and drawers removed. Thus, at the lowest level of the cooking enclosure are several gas burners 28. These burners 28, in other embodiments, will substantially vary in shape, BTU capacity, placement, and number according to needs of the customer and design of the particular grill. Fuel, in this case propane, is delivered to the burners by standard propane gas lines 30. FIG. 3a demonstrates a partial, superior view of the cooking enclosure with the grills in place and the laterally placed shelves removed. FIG. 4a is a sectional view of the cooking enclosure portraying the gas burners 28, the slideable drawers 20, drip guards 32, and superiorly placed grills 22.

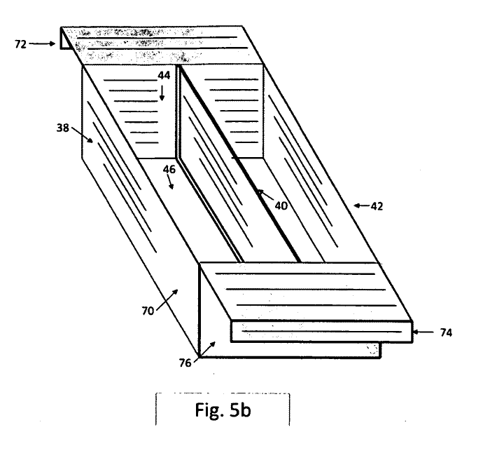

FIG. 5a is an isometric view of the refillable drawer assembly 20, removed from the cooking device. The drawer 20 has a handle 36, a left sided wall 38, a front wall 76, a center wall 40, a right sided wall 42, a back wall 44, and a lower surface 46. The drawer can be opened and filled during operation of the grill, without opening the clamshell hood, avoiding the escape of heat and gasses. The drawer can consist of a variety of design features in different embodiments, which may better control heat exposure, splashing, or other traits of the drawer or drawers. The present embodiment is only the simplest of many choices. The key to the drawers is not the design features per se, but rather their unique function in the cooking process. The drawer can be filled with wood, water, or other substances. They can be refilled without interrupting the cooking process. The drawers provide for the use of both wood and water, enabling slow smoking, while wood alone could be used to simulate cooking over a wood fire through the creation of smoke from burning wood. Water alone would enable the steaming process.

A second embodiment is shown in FIGS. 1, 2, 3b, 4b, and 5b. In this embodiment, the grill retains the flexibility of multiple cooking techniques, but the drawers are no longer slideable. Because manufacturing costs would be less, and existing grills may have improved utility from this invention, the drawers may function as a standalone adaptation. In this embodiment, the drawers lose one function, they do not slide, but still enable the wide variety of improved cooking techniques that make the invention unique.

In this second embodiment, in FIG. 1b, we see that from the exterior view, there is no difference from a standard propane grill available for sale. Unlike FIG. 1a, there is no drawer visible from the front of the grill. In FIG. 3b, rather than a cooking surface of only grills, we see a change from FIG. 3b, such that a refillable drawer 70 is now present. Like the slideable drawer, the fixed drawer also has a bottom surface 46, upstanding walls on the left 38, center 40, front 74, right 42, and a back wall 44. However, the fixed drawer requires a support structure in order to be fixed in one place within the enclosure, one embodiment of which is shown as 72 and 74. The sectional view in FIG. 4a differs from that shown in FIG. 4b, in that the drawers occupy space that would otherwise be available for grilling food. However, the device has the same function as the preferred embodiment in delivering flexibility of cooking technique while delivering the ease of use of, in this case, propane cooking.

It will be seen that a new and useful gas grill has been illustrated and described, and it will be obvious to those skilled in the art that various changes, modifications, and additions can be made without sacrificing the essence of the invention. For example, the bottom surface of the drawers will vary in a manner allowing for improved transfer of heat. Another change would involve alterations of the placement and number of burners, the placement of the drawers, or the size of the grill. The second embodiment may have telescoping arms added, such that the size is variable and it can be placed into grills of varying sizes. These and other changes may be made without sacrificing the unique capability of the device to perform simple grilling, fast smoking, slow smoking, and simulation of cooking over a wood fire.

I claim:

1. A barbecue grill, comprising:
a. A cooking enclosure;
b. A support structure for the cooking enclosure;
c. An energy supply for the cooking enclosure and a manner for delivering energy to the enclosure;
d. Within the cooking enclosure:
i. heating elements in the lower portion;
ii. above the heating elements, grills or other structures to support food items and expose them to the cooking environment;
e. in proximity to one or more of the heating elements, a sliding drawer, or drawers, for exposing wood, water, or other substances to heat;
f. A single cooking device capable of cooking food using gas or other such fuel, but also providing for the capability of controllably adding other substances into the internal cooking environment, such as wood or water, via sliding, refillable drawers placed within the cooking environment, thus enabling the fast and slow smoking processes, and the simulation of cooking over a wood fire.

2. One embodiment of the invention, containing fixed drawers removably placed within a barbecue grill.
